(19) United States
(12) Patent Application Publication
(10) Pub. No.: US 2023/0330597 A1
(43) Pub. Date: Oct. 19, 2023

(54) A METHOD AND A DEVICE FOR INFLUENCING ENTITIES IN A GAS FLOW

(71) Applicant: FILTSON OY, Espoo (FI)

(72) Inventors: Henri SILJANEN, KUOPIO (FI); Balasubramanian NALLANNAN, Espoo (FI); Heikki J. NIEMINEN, HELSINKI (FI)

(21) Appl. No.: 17/906,551

(22) PCT Filed: Feb. 25, 2021
(86) PCT No.: PCT/FI2021/050140

§ 371 Date: Sep. 16, 2022

(30) Foreign Application Priority Data
Mar. 18, 2020 (FI) 20205277

(51) Int. Cl. B01D 53/78; B01D 53/84

(52) U.S. Cl. CPC B01D 53/78; B01D 53/84; B01D 2257/402; B01D 2257/504; B01D 2257/7025; B01D 2257/91

(57) ABSTRACT

The disclosure relates to a method for influencing entities in a gas flow. The method comprises manipulating a platformin situ biologically and/or chemically so as to arrange the platform to be capable of influencing an entity in the gas flow, and allowing the gas flow to advance through the platform or parallel to a surface of the platform so as to influence at least some of the entities in the gas flow. The disclosure further relates to a device for influencing entities in a gas flow. The device comprises a platform being arranged to influence an entity in a gas flow by allowing the gas flow to advance through the platform or parallel to a surface of the platform, and a manipulating means for manipulating the platform in situ biologically and/or chemically. Still further the disclosure relates to a two-staged ultrasound atomizer for manipulating a platform in situ biologically and/or chemically for influencing entities in a gas flow.

### TECHNICAL FIELD

This specification relates to a method and a device for influencing entities in a gas flow. Further, the specification relates to a method and a device wherein a platform is manipulated in situ biologically and/or chemically, the platform being arranged to be capable of influencing an entity in the gas flow. Still further, the specification relates to a two-staged ultrasound atomizer for manipulating a platform in situ biologically and/or chemically for influencing entities in a gas flow.

### BACKGROUND

Climate change is a major human health threat on the Earth, and it causes large socio-economical challenges at present and in the future. These health problems are related to for example increased air, water and soil temperature, increased precipitation, increased air moisture, increased sea level, increased extreme weather events, increased outbreaks of pathogens (caused by bacteria, archaea, fungi, protozoa or viruses). The reason of climate change is emissions and increased production of greenhouse gases (GHGs) after pre-industrial times. Currently there are limited tools to remove GHGs from the atmosphere cost-effectively. Further, GHG removal tools available for all user groups (e.g. industrial companies, small enterprises, private users) are limited.

The World Health Organization (WHO) has announced that climate change is the largest human health threat of children born today. The atmospheric concentration of greenhouse gases carbon dioxide (CO₂), methane (CH₄) and nitrous oxide (N₂O) are above the pre-industrial levels and their concentrations have been increasing every year.

Greenhouse gases, once emission is released to the atmosphere, require a lot of energy and effort to collect them back from the atmosphere. Therefore, most of the efforts to mitigate climate change is related to CO₂ emission reductions and compensations of emissions by off-setting them with technological improvements in developing countries. To keep global warming below 1.5° C. by year 2100, about 670 Gtn of carbon equivalent emissions (concentration of all greenhouse gases converted with global warming potential factor into CO₂, CO₂e) (= 670 000 Tg CO₂e) is needed to be removed from atmosphere (meaning annual reduction of 16-19 GtCO₂e per year). However, the reduction of emissions are not enough and development of GHG removal technologies are needed.

Nitrous oxide is emitted annually about 17.6 Tg to the atmosphere, mostly due to man-made actions including fertilizer production, biomass burning, agriculture and landuse changes. The only biological sink of N₂O is microbial reduction of N₂O to N₂. This process is estimated to consume atmospheric N₂O in natural wetlands and forests annually by 0.3 Tg of N₂O.

Annually about 500-600 Tg of CH₄ is emitted to the atmosphere from anthprogenic (man made) and natural sources. Major emitters are natural wetlands (115-140 Tg/a) and ruminants (85-100 Tg/a). Major part of CH₄ is consumed by OH-radical reactions in stratospheric layer in atmosphere. But there is also biological sink by methanotrophic microbes for low atmospheric concentration in forest and grassland soils. This atmospheric sink strength is about 30-40 Tg CH₄ per year.

Almost all actions of humans maintaining our societies alive and active keep producing greenhouse gases, but there is only limited and expensive approaches for the removal of these GHGs from the atmosphere to hinder impact of climate change. Available GHG removal approaches (such as carbon capture and storage, i.e. CSS) are expensive investments and those approaches are working at industrial scale. Approaches that anyone including consumers could use to remove GHGs from atmosphere do not exist.

GHG removal from the atmosphere can be divided into two major strategies: natural and technological approaches. Natural GHG removal approaches include improvements of natural processes capturing and consuming GHGs in the nature. This means for example land-use changes supporting growth of forests and maintenance and protection of other natural ecosystems, such as wetlands, forests and grasslands capturing GHGs from the atmosphere. In these ecosystems there is a vast diversity of micro-organisms sequestrating CO₂ (e.g. autotrophic ammonia oxidizing microbes), CH₄ (anaerobic e.g. ANME organisms and Bathyarchaeia and aerobic methanotrophs of Gamma-and Alphaproteobacteria and Verrucomicrobia lineages) and N₂O (phylogenetically distinctive Clade 1 and Clade 2 bacteria and archaea). Technological approaches aim at the removal of CO₂ and other GHGs directly from atmosphere, and also on the manipulation of natural carbon removal processes. Forests in general can act as atmospheric sinks for methane and also for nitrous oxide.

Carbon capture and storage (CCS) technology is one of the industrial scale technologies, which is used to remove CO₂ from the atmosphere. In CCS technology, CO₂ is reacting with minerals (e.g. basalt rock) forming carbonates and this liquid is then stored under ground. Another approach is to produce liquid fuel from captured carbon and sell it as a petrol. However, these methods do not capture other more stronger GHGs than CO₂ such as CH₄ or N₂O.

There are also catalyst based technologies available in the markets to remove N₂O from air. These technologies use chemicals and metal-catalysts to reduce N₂O to N₂ and to bind that to the solid material. However, limitations of these technologies are that those are not working efficiently at very low close to atmospheric concentrations of gases (atmospheric concentration of N₂O about 300 ppb), and very high temperature (>400° C.) is needed for catalytic reaction.

### SUMMARY

It is an aim of this specification to provide a method and a device for influencing entities in a gas flow. The method and the device are aimed for having an effect on chemical and/or physical composition of the gas flow. Influencing entities may be performed for example by entirely eliminating entities from the gas flow or reducing an amount of the entity in the gas. Said entities may be unwanted entities such as greenhouse gases, viruses, bacteria or fungi.

According to an embodiment, a method for influencing entities in a gas flow is provided. The method comprises manipulating a platform in situ biologically and/or chemically so as to arrange the platform to be capable of influencing an entity in the gas flow, and allowing the gas flow to advance through the platform or parallel to a surface of the platform so as to influence at least some of the entities in the gas flow.

According to an embodiment, a device for influencing entities in a gas flow is provided. The device comprises a platform being arranged to influence an entity in a gas flow by allowing the gas flow to advance through the platform or parallel to a surface of the platform, and a manipulating means for manipulating the platform in situ biologically and/or chemically.

According to an embodiment, a two-staged ultrasound atomizer for manipulating a platform in situ biologically and/or chemically for influencing entities in a gas flow is provided. The two-staged ultrasound atomizer comprises a liquid supply unit for supplying liquid, a liquification unit for sprinkling the liquid, and an ultrasound atomizer arranged to control size of droplets of the liquid produced by the two-staged ultrasound atomizer.

### BRIEF DESCRIPTION OF THE DRAWINGS

The figures are presented to illustrate the disclosed exemplary embodiments, and are not to be taken to be limiting the scope of their use. The figures are not in any particular scale.

FIG. 1 illustrates, by way of an example, a method for influencing entities in a gas flow,

FIG. 2 illustrates, by way of an example, a method and a device according to an embodiment,

FIG. 3 illustrates, by way of an example, a method and a device according to another embodiment,

FIG. 4 illustrates, by way of an example, a method and a device according to yet another embodiment,

FIG. 5 illustrates activation of airborne N₂O consuming microbes in aerobic conditions,

FIG. 6 illustrates exemplary frames of different ultrasound methods obtained by optical high speed imaging, and

FIG. 7 illustrates estimated droplet size as a function of ultrasound frequency.

### DETAILED DESCRIPTION

The solution is described in the following in more detail with reference to some embodiments, which shall not be regarded as limiting.

In this description and claims, the percentage values relating to an amount of a material are percentages by weight (wt.%) unless otherwise indicated. Term “comprising” may be used as an open term, but it also comprises the closed term “consisting of”.

Within context of this specification, term “entity” refers to a component in the gas flow, such as a gas, a micro-organism or a virus, that may have unwanted effects on ecosystems, biodiversity, human livelihoods, humans and/or technical arrangements or flow systems. The entity may also be called an unwanted entity. The unwanted entity may be one of causing climate change or disease. The unwanted entities which are gases comprise for example greenhouse gases (GHGs). GHG is a gas that absorbs and emits radiation energy within the thermal infrared range. GHGs cause the greenhouse effect on planets. The primary GHGs in the Earth’s atmosphere include water vapor (H₂O), carbon dioxide (CO₂), methane (CH₄), nitrous oxide (N₂O) and ozone (O₃). The unwanted entities which are gases also comprise air pollutant gases, such as volatile organic compounds (VOCs). The unwanted entity may be a micro-organism also referred to as a microbe. Examples of micro-organisms include archaea, bacteria, protists and fungi. The unwanted entity may be a virus, for example a bacteriophage, influenza virus, norovirus, adenovirus or corona virus. The unwanted entity may be a micro-organism or a virus producing for example GHGs, influencing on production or consumption of GHGs or causing other health problems.

This specification aims to provide solutions for influencing entities in gas flow(s). The gas flow comprises the entities, in other words carries the entities. The gas flow can be any composition or mixture of one or more gases and/or micro-organisms and/or viruses. Within context of this specification term “influencing” may refer to a process of having an effect on chemical and/or physical composition of the gas flow. Influencing entities may for example refer to a process of entirely eliminating unwanted entities from the gas flow or to a process wherein the amount of the unwanted entity is reduced, i.e. the amount of the unwanted entity in the incoming gas flow, i.e. the gas flow to be treated, is higher than the amount of unwanted entity in the outgoing gas flow, i.e. in the treated gas flow. Influencing entities may be referred to as removing entities.

Air ventilation devices form a superior tool to purify the air, since those circulate or those are passed by billions or even trillions of litres of air all over the Earth every minute globally. Within context of this disclosure, air ventilation devices include for example airpumps, ventilation tubes as well as all other approaches relying on moving air or to be movable by air, such as a wind power plant. Currently there are no technologies available to use conventional air ventilation devices for GHG removal purposes. Companies using and developing GHG removal technologies would get a huge competitive advance over others in the market because of increasing public awareness about climate change and increasing regulation of emission. Development of such technologies, which could be used together with air-ventilation devices, provides a possiblity for customers to remove GHGs from the atmosphere. It is estimated that with the approach according to this disclosure there is potential to remove for example N₂O from atmosphere at a gigaton scale globally. Establishments of “atmosphere cleanup factories for N₂O” virtually to any building may take the efficiency to another level.

The disclosed technology may be applied not only in the household air ventilation devices, but also in the purification of industrial exhaust gases. It may be used at industrial scale in air ventilation of industrial processes producing for example N₂O, wherein chemical catalyst technology is not possible to use (because of it’s temperature requirement >400° C.). It may also be used to purify exhaust gases of biomass burning, and vehicles at the end of the exhaust systems, wherein optimum temperature for biological activity can be reached.

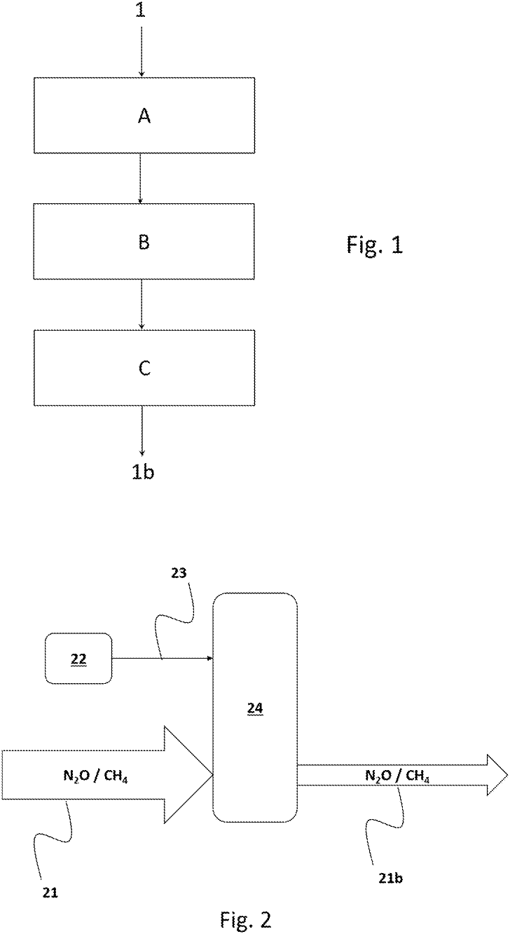

According to an embodiment, a method for influencing entities in a gas flow 1 is provided. The method is illustrated in FIG. 1. The method comprises manipulating a platform biologically and/or chemically in situ (step A of FIG. 1) so as to arrange the platform to be capable of influencing an entity in the gas flow 1, and allowing the gas flow 1 to advance through the platform or parallel to a surface of the platform (step B of FIG. 1) so as to influence at least some of the entities in the gas flow 1 (step C of FIG. 1). As a result, an influenced gas flow 1b is obtained. Steps A-C of the method may be performed simultaneously or in any order other than illustrated in FIG. 1.

Manipulating the platform in situ means that the platform is manipulated, i.e. treated biologically and/or chemically when being in use. Thus, the platform is manipulated when arranged at its place for influencing entities in the gas flow. The platform may be a three-dimensional (3D) pass-through platform, such as a filter. Alternatively, the platform may be a platform movable by a gas flow, such as a rotor blade of a wind power plant. Yet alternatively, the platform may be an inner surface, air-space or a filter located in a chimney pipe of a district heating power and electricity producing plant burning biomass or fossil fuel, or of a fireplace of a house. The platform may be a tube or a pipe or the platform may be located within a tube or a pipe. Cross-section shape of such a pipe or a tube may be circular, oval, square, parallelogram, or irregular shape. Diameter of such a tube or pipe may be from 50 µm to 5 meters.

The platform may be capable of filtering a gas flow. The platform may be intended to air-ventilation and/or air-conditioning and/or air-circulation in for example a building, a filtration plant, factory, district heating plant or an automotive vehicle (such as airplane, motorcycle or car). Ventilation is a process of exchanging or replacing air in any space. Ventilation may be performed in order to provide better indoor air quality. Ventilation includes both the exchange of air to and from the outdoors as well as circulation of air within the building. The platform may also or alternatively remove unwanted gases occurring indoors thereby cleaning the outdoor air. The platform enables passage of gas or is arranged to be in contact with gas flowing parallel to a platform surface. The platform may comprise fibrous or porous material as platform material. The platform material may be arranged to remove solid particulates such as dust, pollen, mold, viruses, fungi, archaea and bacteria from the gas. The platform may be part of a HVAC (heating, ventilation, and air conditioning) system. Alternatively, the platform may be comprised by an exhaust pipe, a catalysator, a chimney or any gas flow device. The platform for influencing entity in a gas flow can be of any scale, for example ranging from industrial to domestic scale. The gas flow to be treated by the platform may comprise air or any component of air. The platform may be a gas filter.

The platform may comprise at least one surface of porous and/or fibrous material, which may be comprised of fibres, beads and/or other porous and/or fibrous material. Pore sizes within porous material (either beads, particles or fibrous material) may have diameter of circular shape and/or length of oval shaped pores for example from 0.5 nm to 5 mm. Distance between particles of porous material (either beads, particles or fibrous material) may be for example from 0.5 nm to 50 mm. For example N₂O reduction at below atmospheric concentration (about 320 ppb) is connected and may be dependent on abundance of small (below 50 µm) particles in the platform material. The porous and/or fibrous material can be arranged on a carrier surface being perpendicular to the gas flow, but it can also be arranged codirectionally or in any angle towards the gas flow. The air flow rate through or by the platform may be for example from 1 litre to 25000 litres per second.

The platform material, especially the filter material, may be manufactured from synthetic materials such as metal, mineral wool, glass wool, fibreglass, activated carbon, LECA, charcoal, vermiculite, ceramics or plastic materials such as polyethylene, polycarbonate, acrylic, polymethyl methacrylate, polypropylene, polyethylene terephthalate, polyvinyl chloride, high-density polyethylene, low-density polyethylene, polypropylene, polystyrene. The filter material may comprise also natural materials. Alternatively, the natural materials may be embedded or sprayed into a plastic holding material. Natural materials or derivatives thereof can be but is not limited to: cotton, cellulose fibre, biochar, chitin, sand, soil, clay, silt, peat, mosses, lichen, hay, grass, compost, mould, wood chips, bark, bark chips, straw, sawdust of wooden materials, resin, lignin, phloem, sap, seeds, peelings of seeds, cellulose, pulp and pulp producing intermediates, black liquor, furfural, tree leaves, tree needles, tree branches, tree roots. Tree species used for filter material can be, but is not limited to: Norway spruce (Picea abies, Picea sp.), Scots pine (Pinus sylvestris, Pinus sp.), Birch (Betula bendula, Betula sp.), Alder (Alnus sp.), Oak (Quercus sp.), Linden (Tilia sp.), Aspen (Populus sp.), Acacia (Fabaceae sp.).

According to an embodiment, the platform comprises micro-organisms and/or viruses. The micro-organisms and/or viruses may be inoculated and/or passively gathered onto and/or into the platform. In an embodiment, the platform is manipulated biologically by inoculating the platform with micro-organisms and/or viruses and/or allowing the micro-organisms and/or viruses to passively gather onto and/or into the platform. The micro-organisms and/or viruses may be provided onto and/or into the platform for example by spraying or embedding the platform material into a medium containing the micro-organisms and/or viruses. The passively gathered microbes are here referred to as airborne microbes.

Examples of the micro-organisms provided and/or passively gathered onto and/or into the platform may include aerobic bacteria or anaerobic bacteria and/or archaea, for example but not limited to these Pseudomonas sp., Marinobacter sp., Neisseria sp., Acetobacteraceae sp., Polaromonas sp., Amaricoccus sp., Janthinobacterium sp., Duganella sp., Paracoccus sp., Luteitalea sp., Bradyrhizobium sp., Prevotella sp., Acidobacteria sp., Cloacibacterium sp., Rhizobium sp., Brucella sp., Ralstonia sp., Cupriavidus sp., Nitratireductor sp., Sulfitobacter sp., Ruegeria sp., Roseovarius sp., Faecalicatena sp., Firmicutes sp., Lycinibacillus sp., Bacillus sp., Pontibaca sp., Pseudoruegeria sp., Azoarcus sp., Polymorphum sp., Azonexus sp., Sulfurisoma sp., Achromobacter sp., Methylococcus sp., Methylomicrobium sp., Methylobacter sp., Methylosinus sp., Methylocystis sp., Verrucomicrobia sp., Methanobacter sp., Methanothermobacter sp., Methanobacterium sp., Methanobrevibacter sp., Methanoregula sp., Mycobacterium sp., Pseudonocardia sp., Verminephorobacter sp., Mesorhizobium sp., Marinovum sp., Aminobacter sp., Azoarcus sp., Pleomorphomonas sp., Gorgonia sp., Rhodococcus sp., Rhodobacter sp., Amycolatopsis sp., Streptomyces sp., Nakamurella sp., Methylibium sp., Skermanella sp., Pelagibaca sp., Acidiphilium sp., Frankia sp., Labrys sp., Aminobacter sp., Nitrosospira sp., Nitrososphaera sp., Nitrososbacter sp., Thiothrix sp., Thiocapsa sp., Thiobacillus sp., Haloarchaea sp., Haloarcula sp., Haloferax sp., Desulfitobacter sp., Thauera sp., Desulfosporosinus sp. More specifically organisms which may passively populate the platform (e.g. air-filter) when using normal atmospheric air, can be closely related with genus Pseudomonas sp., Paracoccus sp., Bradyrhizobium sp., Thiothrix sp., and species Pseudomonas aeruginosa, Pseudomonas stutzeri, Pseudomonas syringae, Pseudomonas fluorescens, Paracoccus denitrificans, Thiothrix lagustris, Thiothrix caldifontis, Bradyrhizobium diazoefficiens.

The micro-organisms may be attached onto and/or into platform by gravitation force, force of air-flow through to the platform, static electric forces, antibodies specific for microbes, non-covalent or covalent attachment to the cell membrane sugar or protein structures, or living or dormant stages (spores or cysts) of cells may be immersed physically into the platform material during the manufacturing of the platform.

One cornerstone of the solution disclosed in here is the finding that besides soils, sediments and water environments, there are viable and active N₂O and CH₄ consuming microbes also in the air and in the atmosphere. Further, said microbes may passively populate for example air-ventilation filters.

According to an embodiment, the micro-organisms inoculated and/or passively gathered onto and/or into the platform are N₂O consuming microbes. N₂O consuming microbes may also be called denitrifying microbes. N₂O consuming microbes are capable of reducing N₂O to dinitrogen (N₂). N2O consuming microbes may also build their biomass with N₂O derived nitrogen. N₂O consuming microbes have an enzyme called nitrous oxide reductase. N₂O consuming microbes use the nitrous oxide reductase to reduce N₂O. Denitrifying and N₂O consuming microbes may be found for example in soil, sediments, in fresh water and/or marine environments, or as living in symbiosis or in parasitism within plants as epiphytic or endophytic microbes. Further, denitrifying and N₂O consuming microbes may be found in air and in air-ventilation systems, and they are referred to as airborne microbes.

According to an embodiment, the micro-organisms inoculated and/or passively gathered onto and/or into the platform are CH₄ consuming microbes. These CH₄ consuming microbes may also be called as methanotrophs or methanotrophic microbes. Methane consuming microbes are capable to oxidize methane to methanol and further to formaldehyde and carbon dioxide with particulate and/or soluble methane monooxygenase enzyme. CH₄ consuming microbes may also build their biomass with CH₄ derived carbon. Methane can be oxidized non-specifically also by homologs of methane monooxygenases, for example activity of propane monooxygenases could be used for methane oxidation. Methanotrophic microbes may be detected in soils, sediments, fresh water and marine environments, or as living in symbiosis or in parasitism within plants as epiphytic or endophytic microbes. These methane oxidizing microbes may be found also in the air and air-ventilation systems, and those are referred to as airborne microbes.

Microbes consuming GHGs may be utilized as nature-based-solution in filters of air-ventilation devices for curation of climate change. However, there are also viruses and protozoa modulating the activity and proliferation of these GHGs consuming microbes, and also other GHG producing microbial communities in all natural ecosystems.

Contribution of the second and third most important GHGs CH₄ and N₂O on global warming is about 19% and 7%, respectively, but the global warming potential (or as simply expressed, harmfulness) is 28 and 300 times higher (within a 100-year-time-horizon) for CH₄ and N₂O, respectively, than for CO₂. Therefore, removal of N₂O from atmosphere would cause the strongest climatic benefit on mass-basis, when compared to the other GHGs CO₂ and CH₄.

In natural ecosystems, N₂O is reduced to molecular dinitrogen (N₂) when availability of nitrogen and oxygen is limitated, with excess of carbon source, with optimal moisture, salinity, and hydrogen ion conditions. N₂O consuming organisms in natural conditions can be activated to consume N₂O after bursts of nutrients and moisture, when growth factors are released due to microbial activity.

Microbial N₂O reduction to dinitrogen (N₂) is an anaerobic process, however it can happen under oxygen if conditions are favorable to create unaerobic reductive conditions in the sample matrix (e.g. moisture content of the matrix material is high, and inorganic nitrogen is limited, and therefore poresize structure and chemical composition is favouring generation of N₂O consuming microsites). Water retention characteristics of material holding N₂O consuming microbes are influencing strongly on potential of microbes reducing N₂O to N₂, or of binding N₂O derived nitrogen into the biomass. If material is capable to keep pore spaces of the material moist enough under drying conditions, microbes will stay active longer.

Microbial methane oxidation is mainly an aerobic process, but it can happen under hypoxia or complete anoxia. Conditions in the sample matrix should favour aerobic conditions and penetration of oxygen into the matrix holding microbes oxidizing CH₄. Such conditions may be dry but moist enough to enable functioning of microbial cells and enzymes catalyzing CH₄ consumption. At the same time conditions in the sample matrix, like supply of growth substrates, vitamins, trace elements, inorganic nitrogen and phosphorus, is favouring CH₄ and/or N₂O consuming microsites. Water retention characteristics of material holding CH₄ consuming microbes are influencing strongly on potential of microbes oxidizing CH₄ to CO₂ or on binding CH₄ derived carbon into the biomass. If material is capable to keep pore spaces of the material moist enough under drying conditions, microbes are able to stay active longer.

Cell shape of microbial consortium can have an effect on its ability to live close to each other and subsequently on its ability to consume N₂O and/or CH₄. Cell shape of microbial consortium can be but is not limited to: coccus, diplococcus, staphylococci, streptococci, sarcina, tetrad, bacillus, coccobacillus, diplobacilli, streptobacilli, palisades, mycobacteria, streptomycetes, vibrio, rod, spore forming rods, club rod, helical, corkscrew, spirochetes, spirillum, filamentous, multicellular filaments, trichomes, gliding gonidia, rosette, haloquadratum.

The method may comprise supplying the platform with a liquid, such as growth medium and/or a chemical agent. The liquid may be arranged to either selectively or non-selectively inhibit, suppress or activate any functional process(es) meaningful for the action of the platform, control proliferation or cell energy metabolism, or facilitate removal of GHG or environmental airborne human health hazard from the gas flow. The liquid may be arranged to adjust at least one of: chemical composition, physical composition, moisture, humidity in and/or on the platform. The liquid may contain more than one phase. The liquid may be an emulsion. The liquid may comprise for example particles, nanoparticles, gas bubbles and/or nanobubbles.

Activity of N₂O and CH₄ consuming microbes, which are passively or actively embedded onto and/or into the platform may be also influenced by growth medium components such as different anions, but not limited to, nitrate (NO₃⁻), nitrite (NO₂⁻), phosphate (PO₄³⁻), sulfate (SO₄²⁻), sulfite (SO₃²⁻), thiosulfate (S₂O₃²⁻), chloride (Cl⁻); and by cations such as but not limited to ammonium (NH₄⁺), potassium (K⁺), sodium (Na⁺), magnesium (Mg²⁺), calcium (Ca²⁺), with amount from 1 mg to 1.5 g per litre in the liquid of growth medium; pH from 1.5 to 9.9, which can be buffered to certain range with buffers such as but not limited to HEPES, tris-EDTA, phosphate-buffer (HPO₄), or HOMO-PIPES; and also by concentration of trace elements, such as but not limited to manganese (Mn), zinc (Zn), cobolt (Co), borium (B), silver (Ag), molybdenium (Mo), copper (Cu), nickel (Ni), iron (Fe), titanium (Ti), selenium (Se), lead (Pb), cadmium (Cd), mercury (Hg), germanium (Ge), with amount from 1 ng to 10 mg per litre in the liquid of growth medium; and by vitamins, such as but not limited to folic acid, B12 vitamin, any vitamin B, vitamin C, vitamin D, any vitamin E, niacin, choline chloride, aminobenzoic acid, panthothenic acid, nicotinic acid, riboflavin, thiamine, biotin, pyridoxine, with amount of 10 µg to 50 mg per litre in the liquid of growth medium; and by different carbon sources, such as but not limited to acetate, glucose, formate, lactose, malate, arabinose, galactose, fructose, sucrose, pyruvate, succinate, creatine, taurine, with concentration from 1 µM to 990 mM in the liquid of growth medium (M = mol/litre); and by different nitrogen sources, such as but not limited to nitrate, nitrite, ammonium, urea, trimethylamine, ethanolamine, methanolamine, glycine or any amino acid or peptide, with concentration from 0.1 µM to 990 mM in the liquid of growth medium; and by different complex medium components such as but not limited to meat extract, yeast extract, peptone, cellulose, hemicellulose, lignin, with concentration from 0.1 to 10% (wt.) in the liquid of growth medium.

According to an embodiment, the viruses and/or bacteria comprised by the gas flow or on the filter are influenced in order to limit their function or viability to produce unwanted entity, for example production of GHG. Alternatively, activity of the viruses and/or bacteria comprised by the gas flow or the filter may be influenced in order to remove the unwanted entity.

As a selective or non-selective microbial growth and/or activity controller one of the following or any combination of the following may be used, but is not limited to: quaternary ammonium, sodium hypochlorite, peracetic acid, hydrogen peroxide, ethanol, sodium carbonate, peroxyhydrate, glycolic acid, L-Lactic acid, triethylene glycol, isopropanol, phenolic, octanoic acid, sodium dischloroisocyanurate dihydrate, sodium dichloro-s-triazinetrione, silver ion, citric acid, hypochlorous acid, thymol, hydrochloric acid, sulphonamides, spectinomycin, amphenicols (e.g. chloramphenicol), tigecycline, trimethoprim, erythromycin, clarithromycin, azithromycin, linezolid, doxycycline, tetracycline, minocycline, penicillins, penicillin G, methicillin, betzathine penicillin, dicloxacillin, flucloxacillin, imipenem, aztreonam, cephalosporin, gentamicin, meropenem, amikacin, levofloxacim, ciplofloxamin, vancomycin, tobramycin, polymycin B, ampicillin, co-amoxiclav, mexaquin, factive, cipro, kanamycin A, amikacin, gentamycin, sisomycin, neomycin, cephalosporin, carbepenems, erythromycin, clarithromycin, tetracyclin, chlortetracycline, oxytetracycline, chlorophenicol, ticarcillin, carboxypenicillin, rifamycin, octane, dicyandiamide, amidinothiourea, acetylene, allylthiourea, carboxy-PTIO, C₁-C₉ alkynes, nitrapyrin, with amount from 0.01 mg to 800 g per litre in the liquid of growth medium.

According to an embodiment, the method comprises supplying the platform with growth medium. The growth medium may be arranged to support the microbial growth. The growth medium may comprise nutrient(s) and/or growth factor(s) for feeding the micro-organisms and for maintaining their activity. The growth medium comprises liquid, wherein the nutrients are dissolved. The nutrients may be delivered to the microbes as liquid packages. The growth medium may be supplied onto and/into the platform for example by passive evaporation of liquid, boiling, passive lateral diffusion of gel formed of the growth medium or spraying of the growth medium into the platform for example with a nozzle or a rotor-like spreading system. The growth medium may be supplied onto and/or into the platform by a system arranged outside or inside the platform. The growth factor and nutrient content as well as chemical and physical properties of the growth medium may be altered to selectively modify the growth and/or activation of specific class, favourably order, more favourably family, more favourably genus, even more favourably species and even more favourably strains of microbes.

The growth medium may comprise at least one of the following or any combination of the following, but not limited to: specific and/or non-specific cell activity inhibitor; specific and/or non-specific cell activator of micro-organism; cell growth or proliferation inhibitor and/or activator; antibiotic; virus-killing agent; antibacterial agent; antifungal agent; epigenetic controller of cell and gene activities of nitrous oxide reductase or methane mono-oxygenase genes or promoter regions or metabolism activities affecting on capacity of the micro-organism to consume or produce GHGs; specific and/or non-specific controller of methylation stage in genomic DNA of microbe and gene activities of nitrous oxide reductase or methane mono-oxygenase genes or promoter regions or metabolism activities affecting on capacity of the micro-organism to consume or produce GHGs; pre/post-transcriptional activity controller (e.g. CRISPR/Cas9 or minimal CRISPR RNA or DNA as plasmid or linearized nucleic acid fragments targeting on promoter regions or open reading frame (ORF) regions functional genes of nitrous oxide reductase or methane mono-oxygenase genes or promoter regions or metabolism activities affecting on capacity of the micro-organism to consume or produce GHGs; or the activity of the microbes can be controlled by genetic elements which are introduced specifically or non-specifically with bacteriophages to target organism.

According to an exemplary embodiment illustrated by FIG. 2, the gas flow 21 comprises N₂O or CH₄. The gas flow 21 is allowed to advance through a platform 24, the platform in this case being a filter. The filter comprises micro-organisms being inoculated and/or passively gathered onto and/or into the filter. The micro-organisms are N₂O/CH₄ consuming microbes. The filter is supplied with a liquid 23, the liquid 23 comprising at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells, viruses modifying activity or genetics of microbial cells, chemical element allowing epigenetic, genetic or transcriptional modification of microbial cell and/or its activity. The liquid may be growth medium. The liquid 23 is supplied by a manipulating means 22, which in this case is a spraying unit. N₂O/CH₄ comprised by the gas flow 21 is influenced by the N₂O/CH₄ consuming microbes such that concentration of N₂O/CH₄ in the influenced gas flow 21b (i.e. gas flow leaving the filter) is smaller than in the uninfluenced gas flow 21 (i.e. gas flow before advancing through the filter).

According to an embodiment, the method comprises supplying the platform with a chemical agent. The chemical agent may comprise at least one of the following: a denaturing agent, a sterilization agent, a disinfecting agent, an alkali or non-alkaline salt.

Influencing entities in the gas flow may be implemented by at least one of the following: accelerating, altering, terminating, weakening, capturing or otherwise controlling the metabolism, growth or multiplication of biological entities (i.e. micro-organisms and/or viruses) in and/or on the platform. Removal, termination, weakening and/or capture of unwanted biological entities and capture or modification of any chemical species in the gas flow may be performed by acting on at least one of the following: increasing reactive surface area, altering metabolic pathways, accelerating metabolism, decelerating metabolism, altering surface-active protein chemistry or capturing unwanted entities. The removal of unwanted entities in a gas flow may be caused by the biological activity of the micro-organisms and/or viruses on the platform, or due to a reaction between entities of the gas flow and chemicals (e.g. primary or secondary metabolites) emitted by micro-organisms and/or viruses on the platform, or due to biological activity and/or interaction of the micro-organisms and/or viruses sprayed on the platform and further modifying activity of the micro-organisms and/or viruses embedded on the platform naturally from atmospheric air, or due to elimination reactions between substance(s) supplied to the platform and the micro-organisms and/or viruses residing on/in the platform. One goal of inhibiting the action of viruses and/or bacteria, or killing them is to limit their capability to infect humans or populations of humans. This approach may be used to control regional epidemies or even a pandemia.

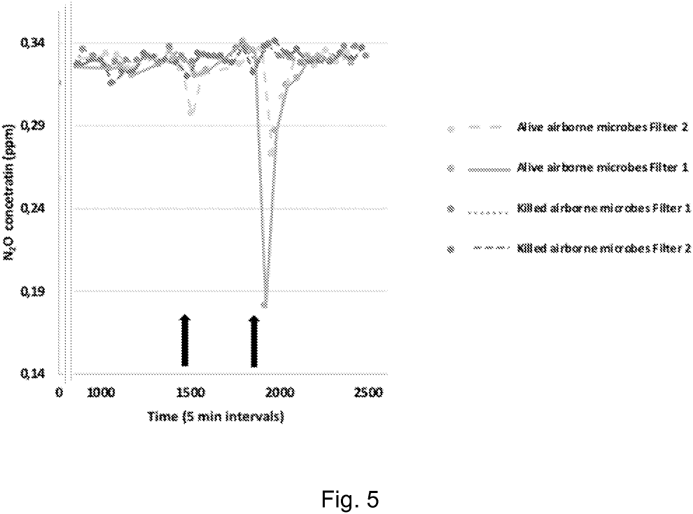

FIG. 5 illustrates an exemplary activation event of airborne N₂O consuming microbes in aerobic conditions on a porous surface in a real-time air flow system (ventilation system), with growth components naturally existing in the air. Timepoints of moisture spraying events (spraying solution contained Na-succinate and NO₃⁻ in natural concentrations existing in wet deposition) with 35 ml of growth medium, events shown with arrows in the illustration causing up to 55-60% reduction in N₂O concentration. The moisture spraying event may be caused with any liquid spraying device. The moisture spraying event may cause 5-100% reduction in concentration of N₂O or CH₄.

In order to deliver the supplied liquid to the microbes on and/or in the platform, the liquid particles, i.e. the liquid packages should be of the right size in order to pass through the platform structure and/or impurities and/or other potential obstacles between the microbes and the liquid packages.

According to an embodiment, the platform is supplied with the liquid by a manipulating means. The manipulating means may be a spraying unit. The spraying unit is arranged to provide a spray of the liquid. The primary object of the spraying unit is to break the bulk liquid and to form fine droplets, thus increasing the surface area of the liquid. The spray may be provided for adjusting chemical composition, physical composition, moisture and/or humidity in and/or on the platform.

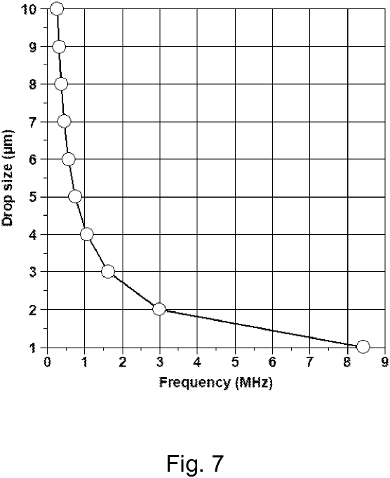

The spraying unit may comprise an atomizer. The atomizer may be an ultrasound atomizer. The ultrasound atomizer may be arranged to ultrasonically generate a microdroplet or aerosol of the liquid. The microdroplet or aerosol of the liquid comprises the liquid packages of suitable size. The droplet size, i.e. diameter of a droplet may be between 10 nm and 2 mm. Preferably the diameter is between 100 nm and 100 µm, more preferably between 300 nm and 30 µm. According to an embodiment, the droplet diameter range in case a platform being a filter is from 1 to 10 µm. FIG. 7 illustrates estimated droplet size as a function of ultrasound frequency.

The ultrasound atomizer may be used to chop the bulk liquid into liquid packages, for example droplets, of desired size as it is capable of achieving a narrow droplet-size distribution. The size of the droplet is important to deposition of said droplet, because for example in the case of filters the pore size of the filter influences how deep said droplet may penetrate. If the droplet is for example 5 µm in diameter, it could in principle pass through a 10 µm pore on the filter without touching the pore boundaries, but not through a 2 µm -sized pore. Therefore, ultrasonic atomizer provides a way to dynamically adjust how deep the liquid droplets are penetrating within the filter. The penetration may be limited to superficial filter or the penetration may be arranged to take place throughout the filter. Microdroplet producer liquid flow rate could be from 10 µl to 100 litre per minute.

Typically, in microchannels, for particles larger than 0.5 µm, deposition increases with increasing particle size, because of increased gravitational and inertial transport, while for particles smaller than 0.5 µm in diameter, deposition increases with decreasing particle size because of increased diffusive transport.

Also, the droplet diameter produced is mainly a function of the vibrating frequency in an ultrasonic atomizer and may be estimated for example by the following equation,

$$\text{D} = 0.34 {\left(8 π σ / \text{ρ} {\text{F}}^{2}\right)}^{\frac{1}{3}}$$

, where D is the droplet diameter (m), σ is the liquid surface tension (N/m), ρ is the liquid density (kg/m³) and F is the vibration frequency (Hz).

Size of the droplets may be controlled by varying at least one of the following: frequency of the capillary wave producing the ultrasound, surface tension in the liquid -gas interface, density of the gas and density of the liquid or the way the capillary waves travelling on the liquid surface are interacting with each other.

Also, according to D² law, the vaporization time of a droplet decreases quadratically with its droplet size. Thus positioning of droplet injection point can be set to achieve the desired droplet size while reaching the deposition surface.

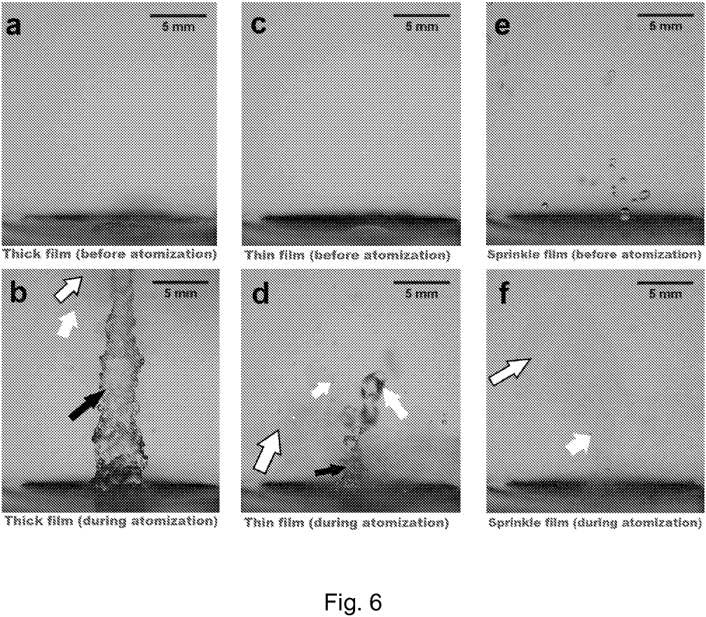

The atomizer may be a two-staged ultrasound atomizer. The two-staged ultrasound atomizer has a liquification unit for producing liquification by using a sprinkling stage, followed by an ultrasound atomizer. Producing liquification may refer to producing small droplets (having a diameter for example of about 100 µm). Producing liquification may refer to sprinkling the liquid. First stage (orifice) droplet size (droplet diameter) may be for example in the range of from 50 µm to 300 µm, as seen in the experiments (FIG. 6). Second stage (atomizer) droplet size may be for example in the range of from 1 to 10 µm. This two-stage method of atomization enables uninterrupted and controlled production of aerosols, even if the mounting of the liquification unit is inclined, apart from elimination of the requirement to maintain a liquid column above the atomizer. The first stage of sprinkling may be performed by feeding liquid through small orifice holes with or without for example liquid pressure, air pressure or swirl assistance. The second stage of atomization may be performed by an ultrasonic atomizer. Thus, the first stage is used to provide coarse atomization and the second stage for fine atomization of liquid.

According to an embodiment, a two-staged ultrasound atomizer comprises a liquid supply unit for supplying liquid, a liquification unit for sprinkling the liquid, and an ultrasound atomizer arranged to control size of droplets of the liquid produced by the two-staged ultrasound atomizer. The liquid supply unit may comprise a liquid tank and a feed pump. The liquid supply unit is arranged to feed the liquid to the liquification unit. The liquification unit may comprise an injection valve. The liquification unit may be arranged to supply the liquid by with pressure to an atomization surface of the ultrasound atomizer. The liquification unit and the ultrasound atomizer may be controlled by a microcontroller.

FIG. 6 illustrates exemplary frames of different ultrasound methods obtained by optical high speed imaging. Top row (a, c, e) demonstrates the pre-sonication state for the different methods. Respectively, the bottom row (b, d, f) demonstrates the sonication phase. The methods comprising forming thick and thin film result in large and small plumes (black arrow), respectively, with micro-droplets (white arrow) and unwanted splashes (white-filled black arrow). Herein the thin film is defined to be a uniform film, regions of liquid film with varying thickness, or small “islands” of liquid produced for example by a single/multiple droplet(s) landing on a transducer surface. The sprinkle method as described above yields in plumeless generation of micro-droplets (f) (white arrow) and limited splashes. The results demonstrate that the two staged approach permits plumeless and essentially splash-free atomization of a liquid. The use of the ultrasound atomizer has the benefit that it is possible to control the size of the droplets. By controlling the size of the droplets it is possible to tune the droplet distribution specifically for each type of platform and/or permeability of the platform. Even distribution of the droplets within the platform may allow for example maintaining the maximal N₂O reduction capability of the platform. Further, controlling the size of the droplets may allow controlling the penetration depth of the droplets within the platform. Moreover, by controlling the size distribution of the droplets it may be possible to have an effect on a contact angle of the droplet and the platform material. The contact angle may have effect on wettability of the platform as hydrophobic structures have a higher contact angle.

According to an embodiment, the platform is manipulated chemically so as to arrange the platform to be capable of influencing an entity in the gas flow. The platform may be manipulated chemically by supplying the platform with a chemical agent.

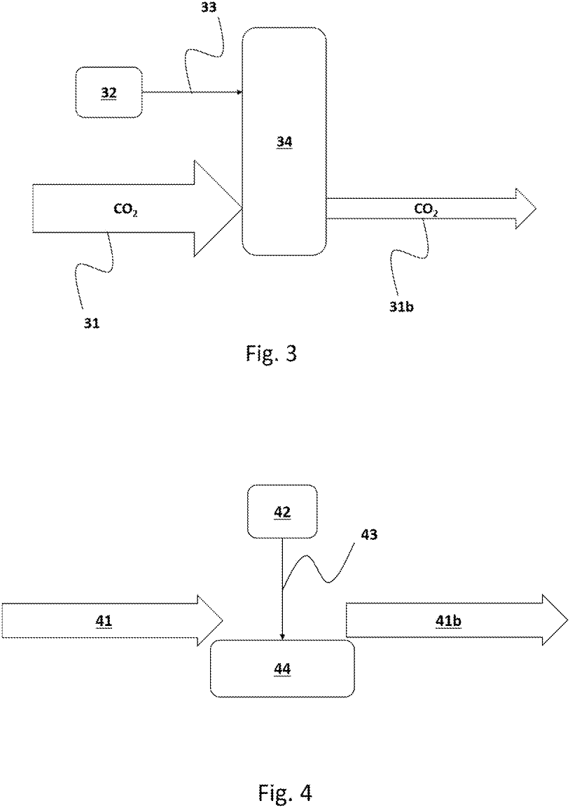

According to an exemplary embodiment illustrated by FIG. 3, the gas flow 31 comprises CO₂. The gas flow 31 is allowed to advance through a platform 34, the platform in this case being a filter. The filter is supplied with a liquid 33, the liquid comprising a chemical agent. The liquid 33 is supplied by a manipulating means 32, which in this case is a spraying unit. CO₂ comprised by the gas flow 31 is influenced by the chemical agent such that concentration of CO₂ in the influenced gas flow 31b (i.e. gas flow leaving the filter) is smaller than in the uninfluenced gas flow 31 (i.e. gas flow before advancing through the filter).

According to an embodiment, the chemical agent comprises alkali salt. The alkali salt is a salt that is a product of neutralisation of a strong base and a weak acid. Alkali salts are bases as implied by their name. Alkali salts may also be referred to as basic salts.

The platform manipulated with the chemical agent comprising alkali salt may be arranged to remove CO₂ from the gas flow. CO₂ of the gas flow may react with the alkali chemical or salt to form carbonate. Chemical agent manipulating the platform may be one of the following or any combination of them, and not limited to: NaOH, KOH, LiOH, salt of any amino acid, any amino acid, NaHCO₃, NaCl, (Li-Na-K)₂CO₃, (Li-K)₂CO₃, CaO, alkaloamine, with concentrations from 1 mM to 30 M.

The platform may be manipulated with the chemical agent by a spraying unit as described above.

According to an embodiment, the platform is manipulated with a killing agent comprising at least one of the following: a virus-killing agent, a bacteria-killing agent or a fungi-killing agent. The killing agent may be a denaturing agent, a sterilization agent and/or a disinfecting agent. The killing agent may be atomized. Droplets comprising the killing agent interact with the viruses and/or bacteria and/or fungi, either in the gas flow or on the platform so that the killing agent achieves the killing function of said viruses and/or bacteria and/or fungi.

The virus-killing agent may for example comprise as an active ingredient at least one of the following: quaternary ammonium, ethanol, sodium chlorite, sodium dichloroisocyanurate dihydrate, sodium hypochlorite, glycolic acid, hydrogen peroxide, peracetic acid, peroxyacetic acid, phenolic, octanoic acid, isopropanol, peroxyoctanoic acid, silver ion, citric acid, ammonium carbonate, ammonium bicarbonate, thymol, sodium dichloro-s-triazinetrione, hydrochloric acid, hypochlorous acid, triethylene glycol, L-lactic acid, sodium carbonate peroxyhydrate, sodium carbonate.

The bacteria-killing agent (i.e. antibacterial agent) based on its chemical structure may for example belong to a group of β-lactams, β-lactam/β-lactamase inhibitor combinations, aminoglycosides, macrolides, quinolones, fluoroquinolones, streptogramins, sulphonamides, tetracyclines or nitroimidazoles.

The fungi-killing agent (i.e. antifungal agent) based on its chemical structure may for example belong to a group of polyenes, azoles, allylamines or echinocandins. Antifungal agents also include aurones, benzoic acid, ciclopirox, 5-fluorocytosine, griseofulvin, haloprogin, tolnaftate, undecylenic acid, triacetin, crystal violet, carbolfuchsin, orotomide, miltefosine, potassium iodide, nikkomycin, coal tar, copper(II) sulphate, selenium disulphide, sodium thiosulphate, piroctone olamine, iodoquinol(diiodohydroxyquin), clioquinol, acrisorcin, zinc pyrithione, sulphur.

The platform may be manipulated by having a secondary gas flow so as to alter the microbe action. The secondary gas flow may comprise for example oxygen so as to feed the microbes with excess oxygen.

According to an embodiment, a device for influencing entities in a gas flow is provided. The device comprises a platform being arranged to influence an entity in the gas flow. The device comprises a manipulating means for manipulating the platform in situ biologically and/or chemically. The manipulating means may be a spraying unit for supplying the platform with a liquid. The liquid may be arranged to adjust at least one of: chemical composition, physical composition, moisture, humidity, in and/or on the platform.

As disclosed above, the spraying unit may comprise a microdroplet producer or an atomizer. The atomizer may be an ultrasound atomizer. The ultrasound atomizer may be modifiable by frequency, pulse duration, pulse shape (sinusoidal/square/sawtooth/whiplash/impulse), pulse duration, pulse repetition rate. In one embodiment time-reversal principles are applied to allow high amplitude superposition at the desired site of atomization. In one embodiment, cavitation is generated within the liquid to generate shock waves for further influence on the capillary waves. The ultrasound atomizer may be controllable by a computer / microcontroller.

The device may further comprise a liquid mixing unit. The liquid mixing unit may be arranged to provide into the liquid at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells (lyzed cells), viruses modifying activity or genetics of microbial cells, chemical element allowing epigenetic, genetic or transcriptional modification of microbial cell and/or its activity.

FIG. 4 illustrates an exemplary embodiment, wherein the gas flow 41 is allowed to advance parallel to a surface of a platform 44. The gas flow 41 comprises an entity, which may be at least one of the following: N₂O, CH₄, CO₂, volatile organic compound, a micro-organism, a virus. The gas flow 41 is arranged to advance parallel to the surface of the platform so as to influence at least some of the entities in the gas flow. Thus, an influenced, in other words treated, gas flow 41b is formed. The platform 44 is manipulated in situ biologically and/or chemically so as to arrange the platform 44 to be capable of influencing the entity in the gas flow 41. The platform 44 is manipulated by supplying the platform with a liquid 43. The liquid 43 is supplied by a manipulating means 42, which in this case is a spraying unit. The liquid 43 may be arranged to adjust at least one of: chemical composition, physical composition, moisture, humidity in and/or on the platform 44. The platform 44 may comprise micro-organisms and/or viruses being inoculated and/or passively gathered onto and/or into the platform 44.

According to an embodiment the device further comprises at least one of the following: a storage device, a processor and at least one sensor. The at least one sensor may belong to group of humidity sensors, moisture sensors, temperature sensors, gas flow sensors, N₂O concentration sensors, CO₂ concentration sensors, CH₄ concentration sensors, VOC concentration sensors, gas flow velocity sensors, air pressure sensors or any other gas identification or gas flow detection sensors.

The sensor data may be stored on the storage device inside or outside the device. The data stored outside the device may be transmitted to the storage device with wire or wirelessly via Bluetooth, wireless local area network or other wireless transmission technology or with mobile data 3G/4G/5G network. The processor may be arranged to analyse the sensor data and use the analysed data to optimize the released droplet composition, size and number provided by the spraying unit. The droplet composition, size and number provided by the spraying unit may be optimized for example to maximize the removal of the unwanted entities.

The device may further comprise at least one of the following: fresh water liquid supply, electric supply (from power grid or from battery), liquid valve, liquid distributor, Wi-Fi router, 3G/4G/5G router or another radio wave router.

In an example, a method for influencing entities in a gas flow is provided. The method comprises
manipulating a platform in situ biologically and/or chemically so as to arrange the platform to be capable of influencing an entity in the gas flow, and
allowing the gas flow to advance through the platform or parallel to a surface of the platform so as to influence at least some of the entities in the gas flow.

The entity may be at least one of the following: N₂O, CH₄, CO₂, volatile organic compound, a micro-organism, a virus.

The platform may be manipulated in situ biologically and/or chemically by supplying the platform with a liquid. The liquid may be arranged to adjust at least one of: chemical composition, physical composition, moisture, humidity, in and/or on the platform. The liquid may comprise at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells, viruses modifying activity or genetics of microbial cells, chemical element allowing epigenetic, genetic or transcriptional modification of microbial cell and/or its activity.

The platform may comprise micro-organisms and/or viruses. The micro-organisms and/or viruses may be inoculated and/or passively gathered onto and/or into the platform.

The method may comprise supplying the platform with growth medium. The method may comprise supplying the platform with a chemical agent.

In an example, a device for influencing entities in a gas flow is provided. The device comprises
a platform that is arranged to influence an entity in a gas flow by allowing the gas flow to advance through the platform or parallel to a surface of the platform, and
a manipulating means for manipulating the platform in situ biologically and/or chemically.

The manipulating means may be a spraying unit for supplying the platform with a liquid.

The device may further comprise a liquid mixing unit arranged to provide into the liquid at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells, viruses modifying activity or genetics of microbial cells, chemical element allowing epigenetic, genetic or transcriptional modification of microbial cell and/or its activity.

The spraying unit may comprise a microdroplet producer or an atomizer. The atomizer may be an ultrasound atomizer. The atomizer may be a two-staged ultrasound atomizer having a liquification unit for producing liquification followed by an ultrasound atomizer.

The device may further comprise at least one of the following: a storage device, a processor and at least one sensor.

In an example, a two-staged ultrasound atomizer for manipulating a platform in situ biologically and/or chemically for influencing entities in a gas flow is provided. The two-staged ultrasound atomizer comprises
a liquid supply unit for supplying liquid,
a liquification unit for sprinkling the liquid, and
an ultrasound atomizer arranged to control size of droplets of the liquid produced by the two-staged ultrasound atomizer.

1. A method for influencing entities in a gas flow, comprising;
manipulating a platform in situ biologically and/or chemically so as to arrange the platform to be capable of influencing an entity in the gas flow, the entity being at least one of the following: N₂O, CH₄, CO₂, a micro-organism, a virus; and
allowing the gas flow to advance through the platform or parallel to a surface of the platform so as to influence at least some of the entities in the gas flow,
wherein the platform comprises micro-organisms, and the platform is manipulated by a spraying unit by supplying the platform with a liquid having a droplet size of between 10 nm and 2 mm and comprising growth medium.

2. The method according to claim 1, wherein the liquid is arranged to adjust at least one of: chemical composition, physical composition, moisture, humidity, in and/or on the platform.

3. The method according to claim 1, wherein the liquid comprises at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells, viruses modifying activity or genetics of microbial cells, chemical element allowing epigenetic, genetic or transcriptional modification of microbial cell and/or its activity.

4. The method according to claim 1 wherein the micro-organisms are being inoculated and/or passively gathered onto and/or into the platform .

5. The method according to claim 1, wherein the method further comprises:
supplying the platform with a chemical agent.

6. A device for influencing entities in a gas flow the entity being at least one of the following: N₂O, CH₄, CO₂, a micro-organism, a virus; and the device comprising:
a platform being arranged to influence an entity in a gas flow by allowing the gas flow to advance through the platform or parallel to a surface of the platform, and
a manipulating means for manipulating the platform in situ biologically and/or chemically,
wherein the platform comprises micro-organisms and/or viruses, and the manipulating means is a spraying unit arranged to supply the platform with a liquid having a droplet size of between 10 nm and 2 mm and comprising growth medium.

7. The device according to claim 6, further comprising a liquid mixing unit arranged to provide into the liquid at least one of: inorganic salt, cell extract, sugar, carbohydrate, protein, fatty acid, phospholipid fatty acid, glycerol, alcohol, ABCDE-vitamin, organic acid, trace element, living microbial cells, resting stages of cells, active traces of cells, viruses modifying activity or genetics of microbial cells, chemical element allowing epigenetic, genetic or transcriptional modification of microbial cell and/or its activity.

8. The device according to claim 6, wherein the spraying unit comprises a microdroplet producer or an atomizer.

9. The device according to claim 8, wherein the atomizer is an ultrasound atomizer.

10. The device according to claim 8, wherein the atomizer is a two-staged ultrasound atomizer having a liquification unit for producing liquification followed by an ultrasound atomizer.

11. The device according to claim 6, further comprising at least one of the following: a storage device, a processor and at least one sensor.

12. (canceled)

13. A method to manipulate a platform by a two-staged ultrasound atomizer in situ biologically and/or chemically for influencing entities in a gas flow, the entity being at least one of the following: N₂O, CH₄, CO₂, a micro-organism, a virus; and the method comprising
supplying liquid by a liquid supply unit,
sprinkling the liquid by a liquification unit, and
controlling size of produced droplets of the liquid by the ultrasound atomizer,
wherein the platform comprises micro-organisms and the liquid comprises growth medium.
